(19) United States
(12) Patent Application Publication
(10) Pub. No.: US 2016/0202947 A1
(43) Pub. Date: Jul. 14, 2016

(54) METHOD AND SYSTEM FOR REMOTE VIEWING VIA WEARABLE ELECTRONIC DEVICES

(71) Applicant: SONY CORPORATION, Tokyo (JP)

(72) Inventors: PRABAKARAN RAMALINGAM, Bangalore (IN); AWADH Bihari MOHAN, Bangalore (IN); ARUN GUNASEKARAN, Bangalore (IN)

(21) Appl. No.: 14/593,246

(22) Filed: Jan. 9, 2015

(51) Int. Cl. G06F 3/14; G06F 3/01; G02B 27/01; G06F 1/16

(52) U.S. Cl. CPC G06F 3/1454; G06F 3/1423; G06F 1/163; G06F 3/017; G06F 3/013; G02B 27/017; G02B 2027/0178

(57) ABSTRACT

Various aspects of a method and system for remote viewing via wearable electronic devices are disclosed herein. In accordance with an embodiment, the method includes communication of a request from a first wearable electronic device to share at least a portion of a field-of-vision (FOV) of a second wearable electronic device. A response is received from the second wearable electronic device as an acknowledgement of the communicated request. A user of the first wearable electronic device may be enabled to view at least the shared portion of the FOV of the second wearable electronic device.

### FIELD

Various embodiments of the disclosure relate to remote viewing. More specifically, various embodiments of the disclosure relate to remote viewing via wearable electronic devices.

### BACKGROUND

Advancements in the field of wearable technology have extended the functionalities of various wearable electronic devices and associated applications. Wearable electronic devices, such as a wearable smart-glass device, are rapidly evolving with respect to their utility as a practical information resource. For example, a user, such as a smart-glass device wearer, may capture a real-world scene and view the captured scene by use of the wearable smart-glass device.

In certain scenarios, it may be difficult for the user to view an object beyond a predefined range of an embedded camera of the wearable smart-glass device. In addition, wearable smart-glass devices may not have the ability to share a field-of-vision among multiple users. Further, the shared field-of-vision may not be controlled as per user preference. Consequently, an enhanced and usable remote viewing experience may not be provided to the smart-glass device wearer.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A method and a system for remote viewing via wearable electronic devices substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates a network environment for remote viewing, in accordance with an embodiment of the disclosure.

FIG. 2 is a block diagram that illustrates an exemplary wearable electronic device, in accordance with an embodiment of the disclosure.

FIG. 3 illustrates a first exemplary scenario for implementation of the disclosed method and system for remote viewing via wearable electronic devices, in accordance with an embodiment of the disclosure.

FIG. 4 illustrates a second exemplary scenario for implementation of the disclosed method and system for remote viewing via wearable electronic devices, in accordance with an embodiment of the disclosure.

FIGS. 5A and 5B collectively depict a flow chart that illustrates an exemplary method for remote viewing via wearable electronic devices, in accordance with an embodiment of the disclosure.

### DETAILED DESCRIPTION

The following described implementations may be found in disclosed method and system for remote viewing via wearable electronic devices. Exemplary aspects of the disclosure may comprise a method that may communicate a request from a first wearable electronic device to share at least a portion of a field-of-vision (FOV) of a second wearable electronic device. A response may be received from the second wearable electronic device as acknowledgement of the communicated request. A user of the first wearable electronic device may be enabled to view at least the shared portion of the FOV of the second wearable electronic device.

In accordance with an embodiment, the first wearable electronic device and the second wearable electronic device may be wearable smart-glass devices. The request to share the portion of the FOV of the second wearable electronic device may be communicated based on a movement of an iris of the user of the first wearable electronic device. In accordance with an embodiment, the request to share the portion of the FOV of the second wearable electronic device may be communicated based on a voice command and/or a gesture command, provided by the user of the first wearable electronic device.

In accordance with an embodiment, the communicated request may further comprise location information of the first wearable electronic device, an authentication request, an image capture request, and/or a video capture request. The request may be communicated from the first wearable electronic device at a first location to the second wearable electronic device at a second location, via a communication network.

In accordance with an embodiment, a line-of-sight and/or an orientation of the shared portion of the FOV of the second wearable electronic device may be controlled based on a movement of an iris of the user of the first wearable electronic device. In accordance with an embodiment, the line-of-sight and/or the orientation of the shared portion of the FOV of the second wearable electronic device may be continuously controlled based on a continuous movement of the iris of the user of the first wearable electronic device. In accordance with an embodiment, the line-of-sight and/or the orientation of the shared portion of the FOV of the second wearable electronic device may be continuously controlled based on the line-of-sight of the iris of the user of the first wearable electronic device at a user-specified timestamp.

In accordance with an embodiment, the line-of-sight and/or the orientation of the shared portion of the FOV of the second wearable electronic device may be controlled based on a voice command and/or a gesture command provided by the user of the first wearable electronic device.

In accordance with an embodiment, the second wearable electronic device and/or one or more other wearable electronic devices may be located based on a user-defined distance parameter and/or direction parameter associated with the first wearable electronic device. In accordance with an embodiment, the second wearable electronic device and/or one or more other wearable electronic devices may be selected based on an analysis of sensor data received from the second wearable electronic device and/or the one or more other wearable electronic devices.

In accordance with an embodiment, the second wearable electronic device and/or one or more other wearable electronic devices may be selected based on a distance, a direction, and/or a position of the second wearable electronic device and/or the one or more other wearable electronic devices. The second wearable electronic device and/or the one or more other wearable electronic devices may be located within a threshold range of a user-defined distance parameter and/or a user-defined direction parameter.

In accordance with an embodiment, the shared portion of the FOV of the second wearable electronic device may be zoomed in and/or zoomed out. In accordance with an embodiment, the shared portion of the FOV of the second wearable electronic device may be panned.

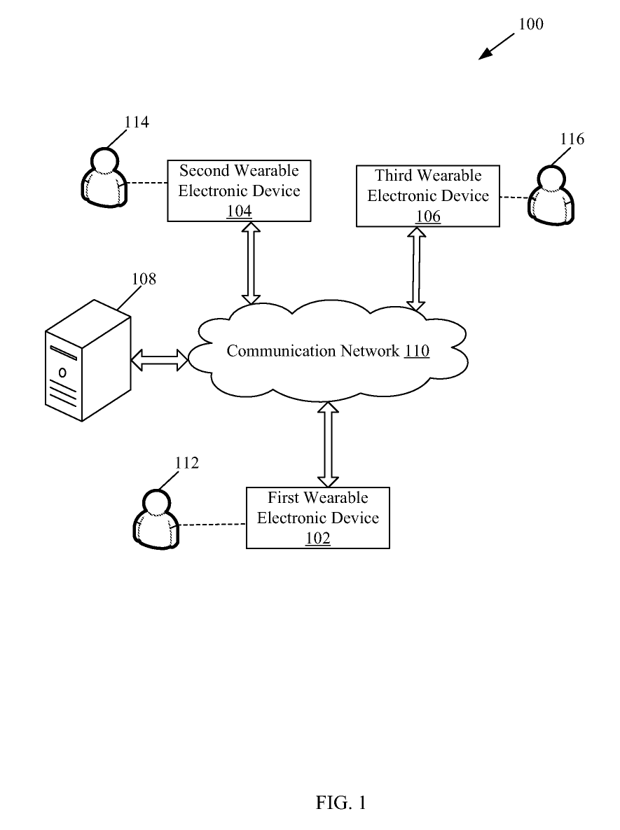

FIG. 1 is a block diagram that illustrates a network environment for remote viewing, in accordance with an embodiment of the disclosure. With reference to FIG. 1, there is shown a network environment 100. The network environment 100 may include a first wearable electronic device 102, a second wearable electronic device 104, and one or more other wearable electronic devices, such as a third wearable electronic device 106. The network environment 100 may further include a server 108, a communication network 110, and one or more users, such as a first user 112, a second user 114, and a third user 116.

The first wearable electronic device 102 may be communicatively coupled to the second wearable electronic device 104, the third wearable electronic device 106, and one or more servers, such as the server 108, via the communication network 110. The first wearable electronic device 102, the second wearable electronic device 104, and the third wearable electronic device 106 may be associated with the first user 112, the second user 114, and the third user 116, respectively.

The first wearable electronic device 102 may comprise suitable logic, circuitry, interfaces, and/or code that may be operable to view at least a portion of a field-of-vision (FOV) shared by the second wearable electronic device 104. The first wearable electronic device 102 may control a line-of-sight and/or an orientation of the shared portion of the FOV of the second wearable electronic device 104. The functionality of the second wearable electronic device 104 and the third wearable electronic device 106 may be similar to the functionality of the first wearable electronic device 102. Examples of the first wearable electronic device 102, the second wearable electronic device 104, and the third wearable electronic device 106 may include, but are not limited to, a smart-glass device, a smart watch, and/or other wearable electronic devices.

The server 108 may comprise suitable logic, circuitry, interfaces, and/or code that may be operable to receive requests from one or more subscribed wearable electronic devices, such as the wearable electronic devices 102 to 106. The server 108 may be implemented by use of several technologies that are well known to those skilled in the art.

The communication network 110 may include a medium through which the first wearable electronic device 102 may communicate with the second wearable electronic device 104, and one or more other wearable electronic devices, such as the third wearable electronic device 106. Examples of the communication network 110 may include, but are not limited to, the Internet, a cellular network, a cloud network, a Wireless Fidelity (Wi-Fi) network, a Wireless Local Area Network (WLAN), a Local Area Network (LAN), a plain old telephone service (POTS), and/or a Metropolitan Area Network (MAN). Various devices in the network environment 100 may be operable to connect to the communication network 110, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

In operation, the first wearable electronic device 102 may be operable to check whether address information of the second wearable electronic device 104 and/or one or more other wearable electronic devices to be connected is provided or not. The address information may correspond to a media access control (MAC) identifier (ID), a subscriber number (such as a cellphone number), a personal identification number (PIN), and/or other device identifier of the second wearable electronic device 104 and/or one or more other wearable electronic devices.

In accordance with an embodiment, the first wearable electronic device 102 may be operable to locate the second wearable electronic device 104, and/or one or more other wearable electronic devices, such as the third wearable electronic device 106. Such location of the second wearable electronic device 104 and/or one or more other wearable electronic devices may occur when the address information of the second wearable electronic device 104 and/or one or more other wearable electronic devices is not provided. The location of the second wearable electronic device 104 and/or one or more other wearable electronic devices may be determined based on a user-defined distance parameter and/or a direction parameter associated with the first wearable electronic device 102. In accordance with an embodiment, the first user 112 may provide an input via a user interface (UI) of the first wearable electronic device 102, which may locate the second wearable electronic device 104, and/or one or more other wearable electronic devices within the user-defined distance parameter and the user-defined direction parameter.

In accordance with an embodiment, first wearable electronic device 102 may be operable to select the second wearable electronic device 104 and/or one or more other wearable electronic devices, such as the third wearable electronic device 106. The selection may occur when the address information of the second wearable electronic device 104 and/or one or more other wearable electronic devices is provided. In accordance with an embodiment, the selection may occur when the second wearable electronic device 104, and/or the one or more other wearable electronic devices are located.

The first wearable electronic device 102 may be operable to communicate a request to share at least a portion of an FOV of the second wearable electronic device 104 (such as the selected wearable electronic device). In accordance with an embodiment, the request may be communicated from the first wearable electronic device 102 at a first location to the second wearable electronic device 104 at a second location, via the communication network 110. The communicated request may comprise a device identifier of the first wearable electronic device 102, location information of the first wearable electronic device 102, address information of the second wearable electronic device 104, an authentication request, an image-capture request, and/or a video-capture request. The authentication request may act as an authentication mechanism to seek allowance or denial of permission from the second wearable electronic device 104 to share the FOV. In accordance with an embodiment, the communicated request may further comprise information related to the line-of-sight of the first user 112, and/or information related to movement of at least an iris of the first user 112 of the first wearable electronic device 102.

In accordance with an embodiment, the second wearable electronic device 104 may be operable to receive the communicated request from the first wearable electronic device 102. In accordance with an embodiment, the second wearable electronic device 104 may be operable to communicate a response to the first wearable electronic device 102 to acknowledge the communicated request. The response from the second wearable electronic device 104 may act as the authentication mechanism to allow or deny permission to share the FOV. For example, the second user 114 of the second wearable electronic device 104 may accept or reject the communicated request. The acceptance may refer to authorization to allow connection with the first wearable electronic device 102. The rejection may refer to denial of connection with the first wearable electronic device 102.

In accordance with an embodiment, the first wearable electronic device 102 may be operable to receive the response from the second wearable electronic device 104, as acknowledgment of the communicated request. For example, the received response may be an acceptance response, such as, “Your request is accepted; providing shared view”. The received response may be a denial response, such as, “Your request is rejected; verify the subscriber number and try again”. In accordance with an embodiment, the response may be text-based response, such as a text message displayed on the first wearable electronic device 102, an audio response, such as a voice message played at the first wearable electronic device 102, or a combination thereof.

In accordance with an embodiment, when the received response is an acceptance response, the first wearable electronic device 102 may be operable to enable the first user 112 to view the shared portion of the FOV of the second wearable electronic device 104. In accordance with an embodiment, the first wearable electronic device 102 may be further operable to simultaneously share at least a portion of an FOV of the first wearable electronic device 102 with the second wearable electronic device 104.

In accordance with an embodiment, the first wearable electronic device 102 may be operable to control the line-of-sight and/or the orientation of the shared portion of the FOV of the second wearable electronic device 104. Such control may occur based on a movement of the iris of the first user 112 of the first wearable electronic device 102. In accordance with an embodiment, such control may occur based on a voice command and/or a gesture command provided by the first user 112.

In accordance with an embodiment, the second wearable electronic device 104 may be operable to dynamically adjust the line-of-sight of at least the portion of the FOV of the second wearable electronic device 104, based on the received information related to the line-of-sight of the first user 112. In accordance with an embodiment, the second wearable electronic device 104 may be operable to continuously synchronize at least the portion of the FOV of the second wearable electronic device 104. Such continuous synchronization may occur based on the received information of the line-of-sight and/or the movement of the iris of the first user 112 of the first wearable electronic device 102 at continuous time intervals.

In accordance with an embodiment, the first wearable electronic device 102 may be operable to zoom in and/or zoom out of the shared portion of the FOV of the second wearable electronic device 104. The first wearable electronic device 102 may be operable to pan the shared portion of the FOV of the second wearable electronic device 104.

In accordance with another aspect of the disclosure, the first wearable electronic device 102 may be operable to utilize the server 108 to locate the second wearable electronic device 104, and/or one or more other wearable electronic devices, such as the third wearable electronic device 106. In accordance with an embodiment, the first user 112, via the first wearable electronic device 102, may communicate a search request to the server 108 to locate the second wearable electronic device 104, and/or one or more other wearable electronic devices within the user-defined distance parameter and the user-defined direction parameter. Based on the search request, the server 108 may be operable to locate the second wearable electronic device 104, and/or one or more other wearable electronic devices, such as the third wearable electronic device 106. The server 108 may be operable to utilize one or more functional services and sensor data to locate the second wearable electronic device 104, and/or the one or more other wearable electronic devices. The functional services may correspond to a map service, a geospatial positioning service, an Internet Protocol (IP)-based telephony service, a cellular-network-based telephony service, and/or a social network service. The sensor data may correspond to the sensor data received from the second wearable electronic device 104, and/or one or more other wearable electronic devices to ascertain favorable FOV-capturing positions and orientations of the located wearable electronic devices.

The server 108 may be operable to map distance, direction, and/or position of the located second wearable electronic device 104, and/or one or more other wearable electronic devices with respect to the first wearable electronic device 102. The position of the second wearable electronic device 104, and/or one or more other wearable electronic devices may be mapped within a threshold range along the path up to the user-defined distance in the user-defined direction.

The server 108 may be operable to select the second wearable electronic device 104 and/or one or more other wearable electronic devices, such as the third wearable electronic device 106. Such a selection may occur based on an analysis of the sensor data received from the second wearable electronic device 104 and/or the one or more other wearable electronic devices.

In accordance with an embodiment, the selection may occur based on a position of the second wearable electronic device 104 and/or the one or more other wearable electronic devices located within a threshold range of the user-defined distance parameter and/or the user-defined direction parameter. In accordance with an embodiment, such a selection may occur based on a user preference. For example, the server 108 may be operable to present the selected second wearable electronic device 104 and/or the one or more other wearable electronic devices on the UI rendered on the display of the first wearable electronic device 102. Such presentation of the second wearable electronic device 104 and/or the one or more other wearable electronic devices may be listed in order of priority or nearest identified device with respect to the user-defined parameters of distance, direction, and/or geographical coordinates. In such an instance, the first wearable electronic device 102 may be operable to receive further user selection from the provided list to connect to the selected wearable electronic device. In accordance with an embodiment, the server 108 may be operable to establish connection to the selected wearable electronic device. For example, the first wearable electronic device 102 may be operable to connect to the selected wearable electronic device, such as the second wearable electronic device 104, by communication of a request to share a portion of an FOV of the selected wearable electronic device, as described above. Notwithstanding, the disclosure may not be so limited, and more than one wearable electronic device, such as the second wearable electronic device 104 and the third wearable electronic device 106, may be selected, without deviating from the scope of the disclosure.

In accordance with an embodiment, the request to share a portion of the FOV of the selected wearable electronic device, may first be communicated to the server 108. The server 108 may be operable to analyze the request, and subsequently communicate the analyzed request to the selected wearable electronic device. Such communication by the server 108 may be based on the address information provided in the communicated request. In accordance with an embodiment, the request may be directly communicated to the selected wearable electronic device, via the communication network 110.

The selected wearable electronic device that receives the request may capture the FOV. The selected wearable electronic device may share the FOV with the first wearable electronic device 102. The first wearable electronic device 102 may be operable to provide a view of the shared portion of the FOV of the selected wearable electronic device to the first user 112. As the selected wearable electronic device is located at a remote location (such as in vicinity to the near user-defined distance), a remote ‘zoom-like effect’ may be experienced by the first user 112 when the shared portion of the FOV of the selected wearable electronic device is viewed.

In accordance with an embodiment, the functionalities of the server 108 may be partly or completely implemented in other wearable electronic devices, such as the first wearable electronic device 102. In accordance with an embodiment, the functionalities of the server 108 may be partly or completely implemented in other servers, such as a cloud server, and/or in other computing devices, such as a smartphone, without deviating from the scope of the disclosure.

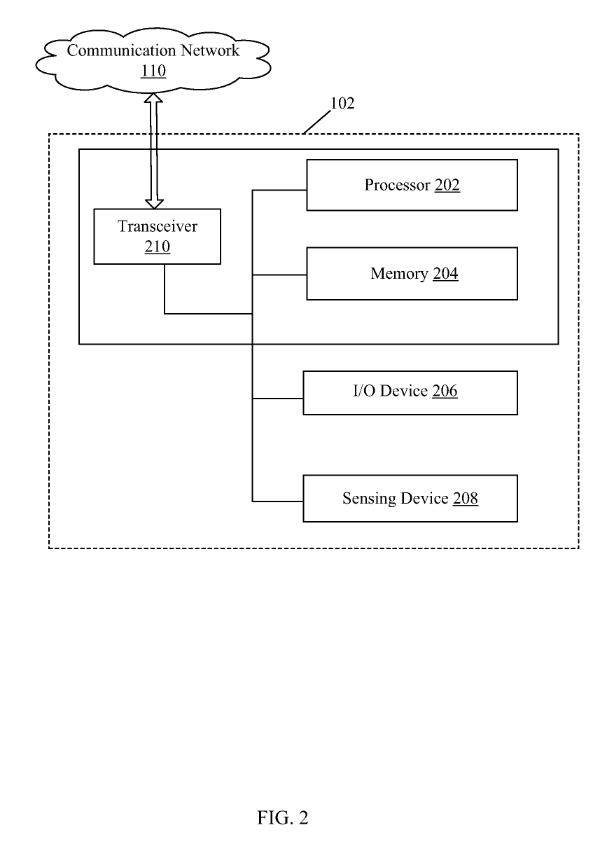

FIG. 2 is a block diagram that illustrates an exemplary wearable electronic device, in accordance with an embodiment of the disclosure. FIG. 2 is explained in conjunction with elements from FIG. 1. With reference to FIG. 2, there is shown the first wearable electronic device 102. The first wearable electronic device 102 may comprise one or more circuits, such as a processor 202, a memory 204, one or more input/output (I/O) devices, such as an I/O device 206, one or more sensing devices, such as a sensing device 208, and a transceiver 210.

The processor 202 may be communicatively coupled to the memory 204, the I/O device 206, the sensing device 208, and the transceiver 210. The transceiver 210 may be operable to communicate with the second wearable electronic device 104 and/or one or more other wearable electronic devices, such as the third wearable electronic device 106, via the communication network 110. In accordance with an embodiment, the transceiver 210 may be operable to communicate with the one or more servers, such as the server 108, via the communication network 110.

The processor 202 may comprise suitable logic, circuitry, interfaces, and/or code that may be operable to execute a set of instructions stored in the memory 204. The processor 202 may be operable to provide a view of a portion of the FOV of the second wearable electronic device 104 that is shared by the second wearable electronic device 104. The processor 202 may control a line-of-sight and/or an orientation of the shared portion of the FOV of the second wearable electronic device 104 or the third wearable electronic device 106. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, a microprocessor, a state machine, and/or other processors.

The memory 204 may comprise suitable logic, circuitry, and/or interfaces that may be operable to store a machine code and/or a computer program with at least one code section executable by the processor 202. The memory 204 may be further operable to store one or more user profiles, one or more text-to-speech conversion algorithms, one or more speech-generation algorithms, and/or other data. The memory 204 may further be operable to store the view that corresponds to the shared portion of the FOV of the second wearable electronic device 104. The view may be a live view stored as a still image and/or as a video. The memory 204 may be further operable to store operating systems and associated applications that may be executed by the processor 202. Examples of implementation of the memory 204 may include, but are not limited to, Random Access Memory (RAM), Read Only Memory (ROM), Hard Disk Drive (HDD), Flash memory, and/or a Secure Digital (SD) card.

The I/O device 206 may comprise suitable logic, circuitry, interfaces, and/or code that may correspond to various input and output devices that may be operable to communicate with the processor 202. The input device may be operable to receive an input from the first user 112. The output device may be operable to provide an output to the first user 112. Examples of the input devices may include, but are not limited to, an image-capturing unit (such as an embedded camera), a touch screen, a microphone, a motion sensor, a light sensor, and/or a docking station. Examples of the output devices may include, but are not limited to, a display screen of smart-glass device, a see-through display, a projection-based display, an electro-chromic display, and/or a speaker. The see-through display may be a transparent or a semi-transparent display. In accordance with an embodiment, the see-through display and/or the projection-based display may generate an optical illusion that the FOV is floating in air at a pre-determined distance from a user's eye, such as the first user 112. The output device may generate a three dimensional (3D) or a two dimensional (2D) view of the FOV.

The image-capturing unit (not shown) may comprise suitable logic, circuitry, interfaces, and/or code that may be operable to capture live views as a still image or a video. The display screen (not shown) may comprise suitable logic, circuitry, interfaces, and/or code that may be operable to display shared portion of an FOV of the second wearable electronic device 104 and/or the third wearable electronic device 106.

The sensing device 208 may comprise suitable logic, circuitry, and/or interfaces that may be operable to store a machine code and/or a computer program with at least one code section executable by the processor 202. The sensing device 208 may comprise one or more sensors for detection of iris movement to determine a gaze direction and/or the line-of-sight of a user, such as the first user 112. The sensing device 208 may further comprise one or more sensors to detect orientation of the first wearable electronic device 102 and/or other gesture detection. The one or more sensors may include biometric sensors, such as a microphone, to detect a voice pattern to confirm recognition, identification, and/or verification of the user, such as the first user 112. Other examples of the one or more sensors may include, but are not limited to, an accelerometer, a global positioning system (GPS) sensor, a compass or magnometer, an ambient light sensor, a tricorder, a gyroscope, a proximity sensor, an image sensor, a lux ete a touch sensor, and/or an infrared sensor.

The transceiver 210 may comprise suitable logic, circuitry, interfaces, and/or code that may be operable to communicate with the second wearable electronic device 104 and/or one or more other wearable electronic devices, such as the third wearable electronic device 106, via the communication network 110. In accordance with an embodiment, the transceiver 210 may be operable to communicate with one or more servers, such as the server 108, via the communication network 110. The transceiver 210 may implement known technologies to support wired or wireless communication of the first wearable electronic device 102 with the communication network 110. The transceiver 210 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The transceiver 210 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), Long Term Evolution (LTE), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

In operation, the processor 202 may be operable to check whether address information of the second wearable electronic device 104 and/or one or more other wearable electronic devices to be connected is provided or not. The address information may correspond to a media access control (MAC) identifier (ID), a subscriber number (such as a cellphone number), and/or a personal identification number (PIN).

In accordance with an embodiment, the processor 202 may be operable to locate the second wearable electronic device 104 and/or the one or more other wearable electronic devices when the address information is not provided. Such location of the wearable electronic devices may occur based on a user-defined distance parameter and/or user-defined direction parameter associated with the first wearable electronic device 102. For example, the first user 112 may provide an input via the UI of the first wearable electronic device 102, which may locate the second wearable electronic device 104 and/or one or more other wearable electronic devices within the user-defined distance and user-defined direction. The UI may correspond to a visual interface that may allow the first user 112 to interact with one or more applications and/or operating systems of the first wearable electronic device 102. The UI may be rendered on a display (not shown) of the first wearable electronic device 102. The input may correspond to a touch-based input or a touch-less input. The touch-based input may comprise a user selection of a UI element rendered on the display of the first wearable electronic device 102. The touch-less input may comprise an audio input or a gesture-based input provided by the first user 112.

In accordance with an embodiment, the processor 202 may be operable to select the second wearable electronic device 104 and/or one or more other wearable electronic devices. In accordance with an embodiment, the selection may be performed when the address information of a wearable electronic device (such as a target wearable electronic device for connection) is provided. For example, the first user 112 may provide an input via the UI of the first wearable electronic device 102 to select the second wearable electronic device 104 and/or one or more other wearable electronic devices.

In accordance with an embodiment, the selection may be performed intelligently by the processor 202 without user intervention. Such selection may occur based on an analysis of sensor data received from the second wearable electronic device 104 and/or the one or more other wearable electronic devices. The sensor data may correspond to lighting conditions, orientation data, and/or resolution of the FOV of the second wearable electronic device 104 and/or the one or more other wearable electronic devices. For example, the processor 202 may select the second wearable electronic device 104 located facing away from sun over the third wearable electronic device 106 located facing towards the sun. In accordance with an embodiment, such selection may occur based on a distance, a direction, and/or a position of the second wearable electronic device 104 and/or the one or more other wearable electronic devices. The position information may correspond to orientation of the located second wearable electronic device 104 and/or the one or more other wearable electronic devices. The position information of the second wearable electronic device 104 and/or the one or more other wearable electronic devices located within the threshold range of the user-defined distance parameter and/or the user-defined direction parameter, may be used for the selection. For example, the user-defined distance parameter may be, “5 kilometers (km)”, and the user-defined direction parameter may be west direction. A distance threshold range, “0 to 5 km”, and direction threshold range, “−30 degrees to +30 degrees, along the line of west direction”, may be preset with reference to the first wearable electronic device 102. The two located wearable electronic devices may be the second wearable electronic device 104 and the third wearable electronic device 106. The second wearable electronic device 104 may be located at a distance, “5.4 km”, and in a direction, “+10 degrees, towards north from the line of west direction”. However, the second wearable electronic device 104 may be positioned with an orientation towards south direction. The third wearable electronic device 106 may be located at a distance, “3.5 km”, and in a direction, “−20 degrees, towards south from the line of west direction”. However, the third wearable electronic device 106 may be positioned with an orientation towards west direction. In this example, the third wearable electronic device 106 may be selected to obtain a desired view.

In accordance with an embodiment, the processor 202 may be operable to communicate a request to share at least a portion of an FOV of the selected second wearable electronic device 104, via the transceiver 210. In accordance with an embodiment, such communication may occur based on a movement of an iris of the first user 112 of the first wearable electronic device 102. In accordance with an embodiment, such communication of the request may occur based on a voice command and/or a gesture command provided by the first user 112. In accordance with an embodiment, the request may be directly communicated when the address information of the second wearable electronic device 104 and/or the one or more other wearable electronic devices is provided. For example, the first user 112 may provide an input via the UI of the first wearable electronic device 102 to communicate the request. The communicated request may comprise an authentication request, a device identifier (ID) of the first wearable electronic device 102, address information of the wearable electronic device to be connected, location information of the first wearable electronic device 102, an image-capture request, and/or a video-capture request.

In accordance with an embodiment, the communicated request may further comprise the line-of-sight information of the first user 112 and/or the information of movement of an iris of the first user 112 of the first wearable electronic device 102. The request may be communicated by the transceiver 210 at a first location to the second wearable electronic device 104 at a second location, via the communication network 110. In accordance with an embodiment, the image-capture request or the video-capture request may be separately communicated to the second wearable electronic device 104 at the second location, by selection of an image-capture mode or a video-capture mode. The image-capture mode or the video-capture mode may be selected via the UI of the first wearable electronic device 102.

In accordance with an embodiment, the processor 202 may be operable to receive a response from the second wearable electronic device 104, as acknowledgment of the communicated request. In accordance with an embodiment, the processor 202 may be operable to receive the response from the one or more other wearable electronic devices. In accordance with an embodiment, the processor 202 may be operable to check whether the received response is an acceptance response or a denial response.

In accordance with an embodiment, the processor 202 may be operable to establish connection to the second wearable electronic device 104 when the response received from the second wearable electronic device 104 is the acceptance response. Similarly, the processor 202 may be operable to establish connection to the one or more other wearable electronic devices when the response(s) received from the one or more other wearable electronic devices is the acceptance response. Such connection may occur based on the device identifier (ID) of the first wearable electronic device 102 provided in the communicated request. In accordance with an embodiment, the processor 202 may be operable to preset the second wearable electronic device 104 and/or the one or more other wearable electronic devices in a trusted devices group, such as a friends and/or family group. Information related to the trusted device group may be updated in the user profile (such as of the first user 112) stored in the memory 204.

In accordance with an embodiment, the processor 202 may be operable to provide a view of the shared portion of the FOV of the connected second wearable electronic device 104 to the first user 112 of the first wearable electronic device 102. In accordance with an embodiment, the processor 202 may be operable to provide a view of the shared portion of the FOV of the one or more other wearable electronic devices at the first wearable electronic device 102. In other words, the processor 202 may be operable to enable the first user 112 to view the shared portion of the FOV of the second wearable electronic device 104 and/or the one or more other wearable electronic devices.

In accordance with an embodiment, the processor 202 may be operable to detect the line-of-sight and/or continuous movement of at least an iris of the first user 112. The iris movement may correspond to the iris movement of a left eye, a right eye, or both eyes. For example, a movement of the iris of the left eye from left direction to right direction, with respect to a reference axis, may be detected by the processor 202.

In accordance with an embodiment, the processor 202 may be operable to communicate information related to the detected line-of-sight and/or the continuous movement of at least an iris of the first user 112. Such information may be communicated to the connected second wearable electronic device 104 and/or the one or more other wearable electronic devices.

In accordance with an embodiment, the processor 202 may be operable to control the line-of-sight and/or the orientation of the shared portion of the FOV of the second wearable electronic device 104 and/or the one or more other wearable electronic devices. Such control may occur based on the movement of the iris of the first user 112 of the first wearable electronic device 102. In accordance with an embodiment, such control may occur based on a voice command and/or a gesture command provided by the first user 112. In accordance with an embodiment, such control of orientation may correspond to control of orientation of an image-capturing unit of the second wearable electronic device 104 and/or the one or more other wearable electronic devices. In accordance with an embodiment, the processor 202 may be operable to continuously control the orientation of the shared portion of the FOV of the second wearable electronic device 104 and/or the one or more other wearable electronic devices. Such continuous control may occur in synchronization to the continuous movement of the iris of the first user 112 of the first wearable electronic device 102.

In accordance with an embodiment, the processor 202 may be operable to zoom in and/or zoom out of the shared portion of the FOV of the second wearable electronic device 104 and/or the one or more other wearable electronic devices. In accordance with an embodiment, the processor 202 may be operable to pan the shared portion of the FOV of the second wearable electronic device 104 and/or the one or more other wearable electronic devices.

In accordance with an embodiment, the processor 202 may be further operable to continuously display shared portion of the FOV of the second wearable electronic device 104. The processor 202 may be further operable to connect to the one or more other electronic devices, such as the third wearable electronic device 106. Based on the connection, shared portion of the FOV of the connected third wearable electronic device 106 may be displayed at the first wearable electronic device 102. In accordance with an embodiment, the processor 202 may be operable to provide a split view that corresponds to both the shared portion of the FOV of the second wearable electronic device 104 and third wearable electronic device 106. The split view may be simultaneously provided and controlled at the first wearable electronic device 102. In accordance with an embodiment, the processor 202 may be operable to provide a view of the shared portion of the FOV of the first wearable electronic device 102 simultaneously to the connected second wearable electronic device 104 and the third wearable electronic device 106.

In accordance with an embodiment, the processor 202 may be operable to record the controlled portion of the FOV of the second wearable electronic device 104 and/or the one or more other wearable electronic devices in the memory 204. In accordance with an embodiment, the recorded portion of the FOV may correspond to an image or a video stream. In accordance with an embodiment, the recorded portion of the FOV may be synchronous to the line-of-sight of the iris of the first user 112 when the recorded portion is an image. In accordance with an embodiment, the recorded portion of the FOV may be synchronous with continuous movement of the iris of the first user 112. The processor 202 may be further operable to display the recorded portion of the FOV of the second wearable electronic device 104 or the selected wearable electronic device, via the I/O device 206.

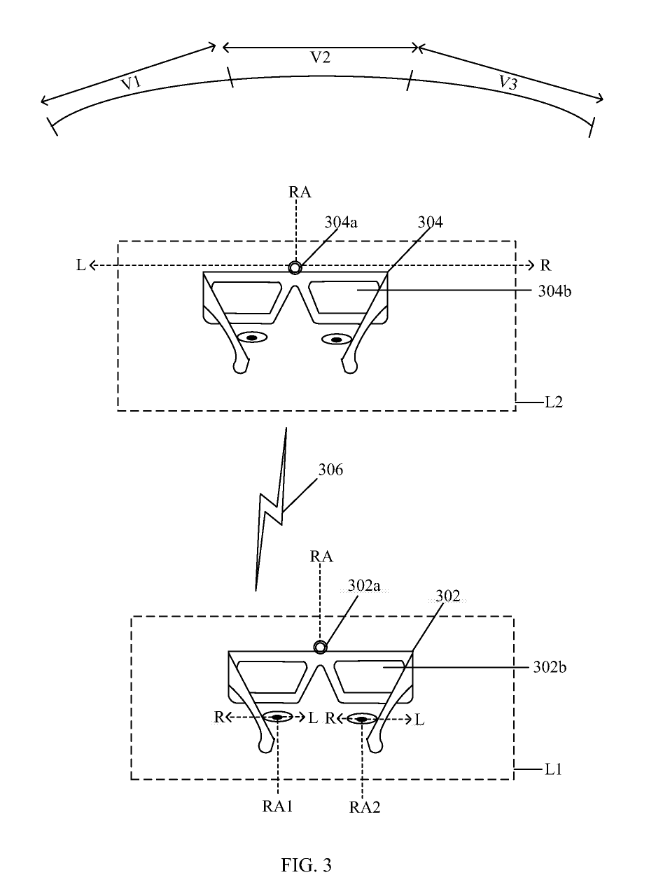

FIG. 3 illustrates a first exemplary scenario for the implementation of the disclosed method and system for remote viewing by use of wearable electronic devices, in accordance with an embodiment of the disclosure. FIG. 3 is explained in conjunction with elements from FIG. 1 and FIG. 2. With reference to FIG. 3, there is shown a first smart-glass device 302, a first camera 302a, a first display 302b, a second smart-glass device 304, a second camera 304a, and a second display 304b. There is further shown a first FOV “V1”, a second FOV “V2”, a third FOV “V3”, a reference axis “RA” for the second camera 304a, a reference axis “RA1” for a left eye of the first user 112, a reference axis “RA2” for a right eye of the first user 112, a left direction “L”, and a right direction “R”. The first smart-glass device 302 is shown at a first location, “L1” and the second smart-glass device 304 is shown at a second location, “L2”.

In accordance with the first exemplary scenario, the first smart-glass device 302 may correspond to the first wearable electronic device 102 (FIG. 1). The second smart-glass device 304 may correspond to the second wearable electronic device 104 (FIG. 1). The first camera 302a and the second camera 304a may correspond to the image-capturing unit (FIG. 2). The first display 302b and the second display 304b may correspond to the display screen (FIG. 2).

With reference to FIG. 3, a user, such as the first user 112 (FIG. 1), may wear the first smart-glass device 302 and another user, such as the second user 114 (FIG. 1), may wear the second smart-glass device 304. The first user 112 at the first location, “L1”, may want to see what the second user 114 at the second location, “L2”, may be viewing. The first user 112 may also want to inspect an area that surrounds the second user 114 in real time. The address information of the second smart-glass device 304 may be provided by the first user 112 of the first smart-glass device 302.

The first smart-glass device 302 may be operable to communicate a request to share at least a portion of an FOV of the second smart-glass device 304. The request may comprise the address information of the second smart-glass device 304. Based on the address information, the request may be communicated from the first smart-glass device 302 at the first location, “L1”, to the second smart-glass device 304 at the second location, “L2”, via the communication network 110. The communicated request may comprise an image-capture request, a video-capture request and/or the device ID, such as “G001” of the first wearable electronic device 102.

The second smart-glass device 304 may be operable to communicate a response to the first smart-glass device 302 to acknowledge receipt of the communicated request. The response may be an input provided by the second user that may indicate an acceptance of the request. The second smart-glass device 304 may be further operable to capture and subsequently share, at least the portion of the FOV. Examples of the captured FOVs may be the FOVs “V1” to “V3”, of the second smart-glass device 304. The FOVs “V1” to “V3”, may be captured by the second camera 304a. In accordance with an embodiment, the captured FOVs “V1” to “V3”, may correspond to the type of request. In other words, the FOVs “V1” to “V3”, may be images when the communicated request comprises an image-capture request and/or the FOVs “V1” to “V3”, may be videos when the communicated request comprises a video-capture request.

The first smart-glass device 302 may be operable to receive the response from the second smart-glass device 304, as an acknowledgment (such as an acceptance) of the communicated request. In accordance with an embodiment, the first smart-glass device 302 may be operable to provide a view of the shared portion of the FOV of the second smart-glass device 304 to the first user 112. Thus, the first user 112 at the first location, “L1”, may be enabled to view what the second user 114 at the second location, “L2”, may be viewing. Similarly, the view captured by the first smart-glass device 302, by use of the first camera 302a, may also be simultaneously shared with the second smart-glass device 304, in accordance with an embodiment.

Further, the first user 112 at the first location, “L1”, may want to control a live view provided by the second smart-glass device at the second location, “L2”. The first user 112 may also want to visualize an area that surrounds the second user 114 in real time, as per preference of the first user 112.

In accordance with an embodiment, the first smart-glass device 302 may be operable to detect a line-of-sight of the left eye of the first user 112. The line-of-sight may be 30 degrees towards a left direction, “L” (of the first user 112), from the reference axis, “RA1”. The first smart-glass device 302 may be further operable to detect continuous movement of at least an iris of the first user 112. The continuous movement may be from the initial left direction, “L” (of the first user 112) to 70 degrees towards right direction, “R” from the reference axis, “RA1” and/or “RA2”.

The first smart-glass device 302 may be operable to communicate the detected line-of-sight information or the continuous movement of at least an iris of the first user 112 to the second smart-glass device 304. Such detected information may be transmitted together with the communicated request. In accordance with an embodiment, such detected information may be communicated subsequent to receipt of the response (acknowledgement) from the second smart-glass device 304, or as per user-preference. In accordance with an embodiment, the first smart-glass device 302 may be operable to control the line-of-sight and/or an orientation of the shared portion of the FOV of the second smart-glass device 304.

In accordance with an embodiment, the second smart-glass device 304 may be operable to dynamically adjust the line-of-sight of at least the portion of the FOV of the second wearable electronic device 104. The dynamic adjustment of the line-of-sight may be based on the received information related to the line-of-sight of the first user 112 in the communicated request. For example, the line-of-sight and/or the orientation of the second camera 304a may be adjusted (such as, 30 degrees towards left direction, “L” from the reference axis, “RA”) to be synchronous to the received line-of-sight information of the first user 112. The second smart-glass device 304 may be operable to capture a first FOV, “V1” via the second camera 304a, based on the adjusted line-of-sight and/or the orientation of the second camera 304a. The second smart-glass device 304 may share the captured first FOV, “V1” with the first smart-glass device 302.

The first smart-glass device 302 may be operable to provide a view of the shared portion of the first FOV, “V1” of the second smart-glass device 304 to the first user 112. The shared portion of the first FOV, “V1” may be displayed on the first display 302b of the first smart-glass device 302.

Similarly, in accordance with an embodiment, the second smart-glass device 304 may be operable to dynamically adjust the orientation of at least the portion of the FOV of the second smart-glass device 304 upon receipt of the stream of continuous movement of at least the iris of the first user 112. For example, the first user 112 may move at least the iris of left eye from an initial left direction, “L” to 70 degrees towards right direction, “R”, with respect to the reference axis “RA1” of the left eye. Accordingly, the orientation of the second camera 304a may be dynamically adjusted from an initial left direction, “L” to 70 degrees towards right direction, “R”, with respect to the reference axis “RA”, of the second smart-glass device 304. Such an adjustment may occur to synchronize the orientation of the second camera 304a to the received stream of continuous movement of the iris of the first user 112.

In accordance with an embodiment, the second smart-glass device 304 may be operable to capture a live view (such as a video) with different FOVs, such as from the first FOV “V1” to the third FOV “V3”. The second smart-glass device 304 may share the captured live view (such as the video stream with controlled FOVs) with the first smart-glass device 302.

The first smart-glass device 302 may be operable to provide the live view of the shared portion of the dynamically changing FOV of the second smart-glass device 304 to the first user 112. Thus, the live view of the area that surrounds the second user 114 may be easily and effectively controlled based on the movement of the iris of the first user 112. The live view may be displayed on the first display 302b of the first smart-glass device 302.

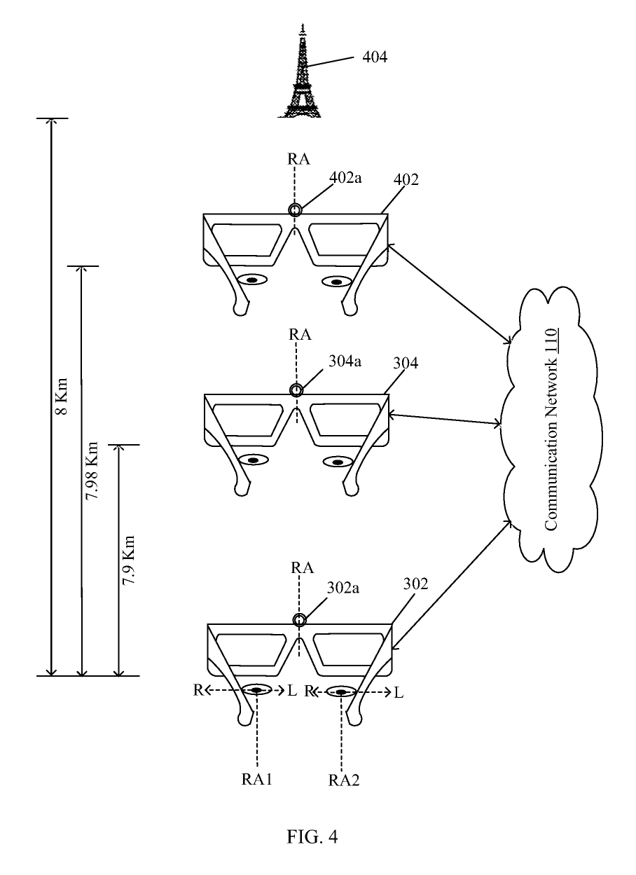

FIG. 4 illustrates a second exemplary scenario for the implementation of the disclosed method and system for remote viewing by use of wearable electronic devices, in accordance with an embodiment of the disclosure. FIG. 4 is explained in conjunction with elements from FIG. 1, FIG. 2 and FIG. 3. With reference to FIG. 4, there is shown a third smart-glass device 402, a third camera 402a, an object 404, and in addition, the communication network 110, the first smart-glass device 302, the first camera 302a, the second smart-glass device 304, the second camera 304a, as described in FIG. 3.

In accordance with the second exemplary scenario, the third smart-glass device 402 may correspond to the third wearable electronic device 106 (FIG. 2). The object 404 may be located at a distant location, such as, “8 km”, from the first smart-glass device 302. The second smart-glass device 304 and the third smart-glass device 402 may be located away at, “7.90 km”, and, “7.98 km”, respectively, from the first smart-glass device 302.

With reference to FIG. 4, the first user 112 may want to view a magnified and clear view of the object 404 situated at, “8 km”. However, the first camera 302a of the first smart-glass device 302 may be a zoom-less, image-capturing device.

In operation, the first smart-glass device 302 may be operable to locate the second smart-glass device 304 and/or one or more other wearable electronic devices, such as the third smart-glass device 402. Such location of the one or more other wearable electronic devices may be based on a user-defined distance parameter and/or user-defined direction parameter associated with the first smart-glass device 302. For example, the first smart-glass device 302 may provide an input, such as “Search wearable electronic devices at a distance of 8 km in a north-east direction”, via a UI of the first smart-glass device 302. Accordingly, the first smart-glass device 302 may be operable to locate one or more other wearable electronic devices, such as the second smart-glass device 304 and the third smart-glass device 402. The first smart-glass device 302 may be operable to map the distance and/or direction of the second smart-glass device 304 and the third smart-glass device 402, which may be located within a threshold range along the path up to, “8 km”, within the user-defined north-east direction. Such location and mapping of the one or more other wearable electronic devices may occur by use of a map service, a geospatial positioning service, sensor data received from the one or more other wearable electronic devices, and/or network signals received from cellular communication network.

The first smart-glass device 302 may be operable to select the second smart-glass device 304, to connect to the second smart-glass device 304. The first smart-glass device 302 may be operable to connect to the second smart-glass device 304, by communication of a request to share a portion of an FOV of the second smart-glass device 304, as described in FIG. 1 and FIG. 2.

The first smart-glass device 302 may be operable to enable the first user 112 of the first smart-glass device 302, to view the shared portion of the FOV of the second smart-glass device 304, which may be located at a distance, “100 meters”, away from the object 404. Thus, a ‘zoom-like effect’ may be created when the first smart-glass device 302 provides a close-up and clear view of the object 404 located at the distant location.

In accordance with an embodiment, the first smart-glass device 302 may be operable to select the third smart-glass device 402 to connect to the third smart-glass device 402, as per user-preference. The third smart-glass device 402 may share the FOV captured by the third camera 402a with the first smart-glass device 302.

The first smart-glass device 302 may be operable to provide a view of the shared portion of the FOV of the third smart-glass device 402 to the first user 112 of the first smart-glass device 302. As the third smart-glass device 402 is located at a distance, “2 meters”, away from the object 404, a ‘zoom-like effect’ may be created when the first smart-glass device 302 provides a close-up and clear view of the object 404 located in the distance.

In accordance with an embodiment, the first smart-glass device 302 may be operable to remotely zoom in, zoom out, pan, and/or control the orientation of the shared portion of the FOV of the second smart-glass device 304 or the third smart-glass device 402. Thus, such operations may provide enhanced visualization of the object 404 located distantly, as per user-preference.

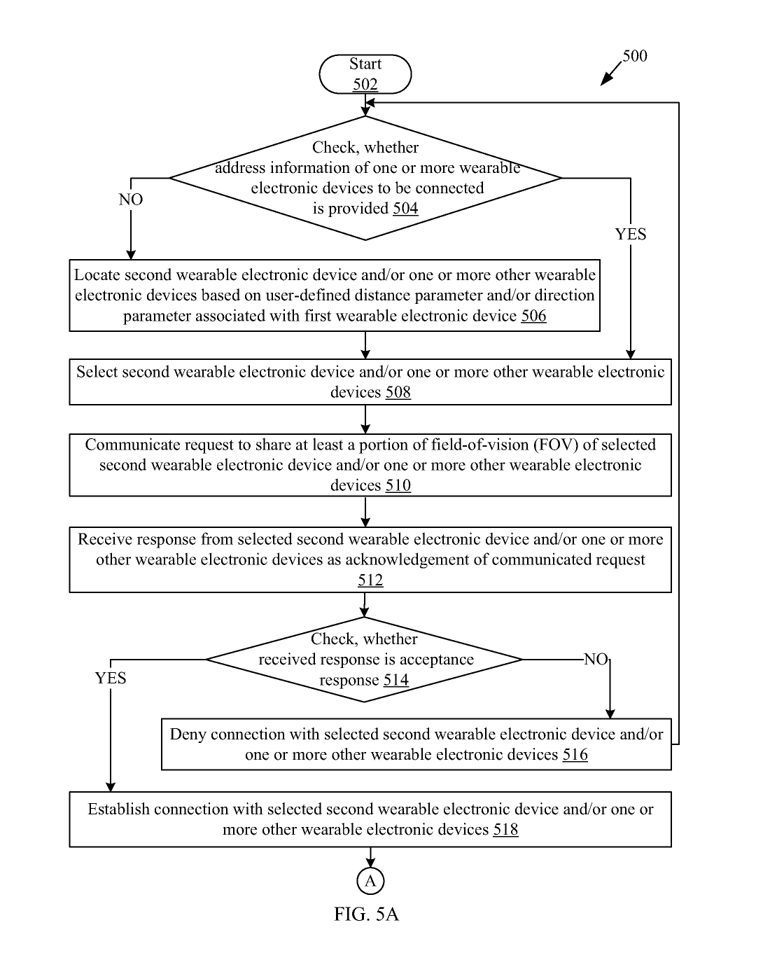

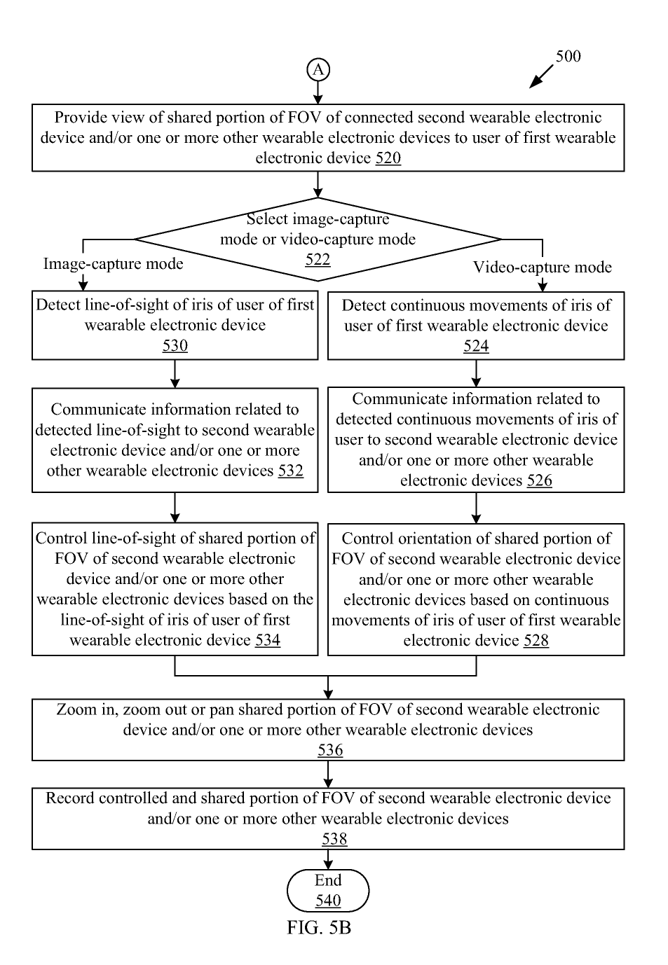

FIGS. 5A and 5B collectively depict a flow chart that illustrates an exemplary method for remote viewing via wearable electronic devices, in accordance with an embodiment of the disclosure. With reference to FIGS. 5A and 5B, there is shown a flow chart 500. The flow chart 500 is described in conjunction with FIG. 1 and FIG. 2. The method starts at step 502 and proceeds to step 504.

At step 504, whether address information of a wearable electronic device to be connected is provided or not, may be checked. In instances when address information is provided, the control passes to step 510. In instances when address information is not provided, the control passes to step 506. At step 506, the second wearable electronic device 104 and/or one or more other wearable electronic devices, may be located. Such location of wearable electronic device(s) may occur based on a user-defined distance parameter and/or user-defined direction parameter associated with the first wearable electronic device 102. In accordance with an embodiment, the second wearable electronic device 104 and/or one or more other wearable electronic devices may be located within a threshold range of a user-defined distance parameter and/or a user-defined direction parameter.

At step 508, one or more wearable electronic device from the located second wearable electronic device 104 and/or one or more other wearable electronic devices, may be selected. Such selection may occur based on an analysis of sensor data received from the second wearable electronic device 104 and/or the one or more other wearable electronic devices. In accordance with an embodiment, such selection of the one or more wearable electronic devices may occur based on a position, distance, and/or direction.

At step 510, a request may be communicated from a first wearable electronic device 102 to share at least a portion of an FOV of the selected second wearable electronic device 104. In accordance with an embodiment, the request may be communicated to one of the one or more other wearable electronic devices, to share at least a portion of an FOV of the selected one or more other wearable electronic devices. In accordance with an embodiment, such a communication of the request may occur based on a movement of an iris of a user, such as the first user 112 of the first wearable electronic device 102. In accordance with an embodiment, such communication of the request may occur based on a voice and/or a gesture command provided by the first user 112 of the first wearable electronic device 102.

At step 512, a response may be received from the selected second wearable electronic device 104 and/or the one or more other wearable electronic devices. The response may correspond to an acknowledgement of the communicated request. At step 514, it may be checked whether the received response is an acceptance response or a denial response. In instances when the received response is the denial response, the control passes to step 516. In instances when the received response is the acceptance response, the control passes to step 518.

At step 516, a connection with the selected second wearable electronic device 104 and/or the one or more other wearable electronic devices, may be denied. In instances when the connection is denied, the control passes back to the step 504 after a user-defined time interval. In accordance with an embodiment, in instances when the connection is denied, the control may pass to the end step 540 as per user-preference. At step 518, a connection with the selected second wearable electronic device 104 and/or the one or more other wearable electronic devices, may be established. Such connection may be established to share the FOV of the selected second wearable electronic device 104 and/or the one or more other wearable devices.

At step 520, a view of the shared portion of the FOV of the connected second wearable electronic device 104 or the one or more other wearable electronic devices, may be provided. Such a view may be provided at the first wearable electronic device 102. In other words, the first user 112 may be enabled to view the shared portion of the FOV of the second wearable electronic device 104 or the one or more other wearable electronic devices. At step 522, the user may select one of an image-capture mode or a video-capture mode at the first wearable electronic device 102. In instances when the video-capture mode is selected, the control passes to step 524. In instances when the image-capture mode is selected, the control passes to step 530.

At step 524, continuous movement of at least an iris of the first user 112, may be detected. In accordance with an embodiment, the movement may correspond to the iris movement of a left eye, a right eye, or both the eyes. At step 526, information related to the detected continuous movement of the iris of the first user 112 may be communicated to the second wearable electronic device 104. In accordance with an embodiment, such information may be communicated to the one or more other wearable electronic devices. In accordance with an embodiment, the communication may occur simultaneously with a video-capture request.

At step 528, an orientation of the shared portion of the FOV of the connected second wearable electronic device 104 and/or the one or more other wearable electronic devices, may be controlled. Such control may occur based on the movement of the iris of the user of the first wearable electronic device 102. In accordance with an embodiment, such control may occur based on a voice and/or a gesture command provided by the first user 112 of the first wearable electronic device 102. The control passes to step 536. In accordance with an embodiment, the control may pass to the step 538 when the first wearable electronic device 102 receives an input from the first user 112 to record the controlled and shared portion of the FOV (not shown). In accordance with an embodiment, the control may pass back to the step 522 when the first wearable electronic device 102 receives an input from the first user 112 to change the mode from the video-capture mode to the image-capture mode (not shown).

At step 530, a line-of-sight of at least an iris of the first user 112, may be detected. In accordance with an embodiment, such line-of-sight detection may correspond to detection of gaze direction of the user, such as the first user 112. At step 532, the information related to the detected line-of-sight of the iris of the first user 112 may be communicated to the second wearable electronic device 104. In accordance with an embodiment, such information may be communicated to the one or more other wearable electronic devices. In accordance with an embodiment, the communication may occur simultaneously with an image-capture request.

At step 534, a line-of-sight of the shared portion of the FOV of the connected second wearable electronic device 104 and/or the one or more other wearable electronic devices, may be controlled. Such control may occur based on the detected line-of-sight of the iris of the first user 112 of the first wearable electronic device 102. In accordance with an embodiment, such control may occur based on a voice and/or a gesture command provided by the first user 112 of the first wearable electronic device 102.

At step 536, the controlled and shared portion of the FOV of the second wearable electronic device 104 or the one or more other wearable electronic devices may be zoomed in or zoomed out. In accordance with an embodiment, the shared portion of the FOV of the second wearable electronic device 104 and/or the one or more other wearable electronic devices may be panned as per the user-preference.

At step 538, the controlled and shared portion of the FOV of the second wearable electronic device 104 and/or the one or more other wearable electronic devices, may be recorded as an image or a video stream. In accordance with an embodiment, the controlled and shared portion of the FOV may correspond to the video stream that is continuously synchronized with continuous movement of the iris of the user of the first wearable electronic device 102. In accordance with an embodiment, the controlled portion of the FOV may correspond to the image (such as image of a remote location) that may be synchronous to line-of-sight of the iris of the first user 112. For example, the controlled portion of the FOV of the second wearable electronic device 104 and/or the one or more other wearable electronic devices may be received as an image. In such an instance, the received image or video stream may be displayed at the first wearable electronic device 102. Control passes to end step 540.

In accordance with an embodiment of the disclosure, a system for remote viewing is disclosed. The system ((such as the first wearable electronic device 102 (FIG. 1)) may comprise one or more processors (hereinafter referred to as the processor 202 (FIG. 2)). The processor 202 may be operable to communicate a request to share at least a portion of an FOV of another wearable electronic device, such as the second wearable electronic device 104 (FIG. 1). The processor 202 may be operable to receive a response from the second wearable electronic device 104 as acknowledgement of the communicated request. The processor 202 may be operable to enable a user, such as the first user 112, of the first wearable electronic device 102, to view at least the shared portion of the FOV of the second wearable electronic device 104.

Various embodiments of the disclosure may provide a non-transitory computer readable medium and/or storage medium, and/or a non-transitory machine readable medium and/or storage medium having stored thereon, a set of computer-executable instructions for causing a machine and/or a computer to remote viewing. The at least one code section in a server may cause the machine and/or computer to perform the steps that comprise communication of a request to share at least a portion of an FOV of the second wearable electronic device 104. A response may be received from the second wearable electronic device 104 as acknowledgement of the communicated request. A user, such as the first user 112 of the first wearable electronic device 102, may be enabled to view at least the shared portion of the FOV of the second wearable electronic device 104.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for remote viewing, the method comprising:
in a first wearable electronic device:
communicating a request to share at least a portion of a field-of-vision (FOV) of a second wearable electronic device;
receiving a response from said second wearable electronic device acknowledging said communicated request; and
enabling a user of said first wearable electronic device to view said shared said at least portion of said FOV of said second wearable electronic device.

2. The method as claimed in claim 1, wherein said first wearable electronic device and said second wearable electronic device are wearable smart-glass devices.

3. The method as claimed in claim 1, wherein said communication of said request is based on a movement of an iris of said user of said first wearable electronic device.

4. The method as claimed in claim 1, wherein said communication of said request is based on one or more of: a voice command and/or a gesture command provided by said user of said first wearable electronic device.

5. The method as claimed in claim 1, wherein said communicated request comprises one or more of: location information of said first wearable electronic device, an authentication request, an image capture request, and/or a video capture request.

6. The method as claimed in claim 1, wherein said request is communicated from said first wearable electronic device at a first location to said second wearable electronic device at a second location, via a communication network.

7. The method as claimed in claim 1, further comprising controlling a line-of-sight and/or an orientation of said shared said at least portion of said FOV of said second wearable electronic device based on a movement of an iris of said user of said first wearable electronic device.

8. The method as claimed in claim 1, further comprising continuously controlling a line-of-sight and/or an orientation of said shared said at least portion of said FOV of said second wearable electronic device based on a continuous movement of an iris of said user of said first wearable electronic device.

9. The method as claimed in claim 1, further comprising controlling a line-of-sight and/or an orientation of said shared said at least portion of said FOV of said second wearable electronic device based on a line-of-sight of said iris of said user of said first wearable electronic device at a user-specified timestamp.

10. The method as claimed in claim 1, further comprising controlling a line-of-sight and/or an orientation of said shared said at least portion of said FOV of said second wearable electronic device based on one or more of: a voice command and/or a gesture command provided by said user of said first wearable electronic device.

11. The method as claimed in claim 1, further comprising locating said second wearable electronic device and/or one or more other wearable electronic devices based on a user-defined distance parameter and/or user-defined direction parameter associated with said first wearable electronic device.

12. The method as claimed in claim 1, further comprising selecting said second wearable electronic device and/or one or more other wearable electronic devices based on analysis of sensor data received from said second wearable electronic device and/or said one or more other wearable electronic devices.

13. The method as claimed in claim 1, further comprising selecting said second wearable electronic device and/or one or more other wearable electronic devices based on a position of said second wearable electronic device and/or said one or more other wearable electronic devices located within a threshold range of a user-defined distance parameter and/or a user-defined direction parameter.

14. The method as claimed in claim 13, wherein said selection provides a zoomed in and/or zoomed out view of said shared said at least portion of said FOV of said second wearable electronic device.

15. The method as claimed in claim 1, further comprising zooming in, zooming out, and/or panning of said shared said at least portion of said FOV of said second wearable electronic device.

16. A system for remote viewing, the system comprising:
one or more circuits in a first wearable electronic device, said one or more circuits being operable to:
communicate a request to share at least a portion of a field-of-vision (FOV) of a second wearable electronic device;
receive a response from said second wearable electronic device acknowledging said communicated request; and
enable a user of said first wearable electronic device to view said shared said at least portion of said FOV of said second wearable electronic device.

17. The system as claimed in claim 16, wherein said communicated request further comprises one or more of: location information of said first wearable electronic device, an authentication request, an image capture request, and/or a video capture request.

18. The system as claimed in claim 16, wherein said request is communicated from said first wearable electronic device at a first location to said second wearable electronic device at a second location, via a communication network.

19. The system as claimed in claim 16, wherein said one or more circuits are further operable to control a line-of-sight and/or an orientation of said shared said at least portion of said FOV of said second wearable electronic device based on a movement of an iris of said user of said first wearable electronic device.

20. The system as claimed in claim 16, wherein said one or more circuits are further operable to control a line-of-sight and/or an orientation of said shared said at least portion of said FOV of said second wearable electronic device based on one or more of: a voice command and/or a gesture command provided by said user of said first wearable electronic device.

21. The system as claimed in claim 16, wherein said one or more circuits are further operable to locate said second wearable electronic device and/or one or more other wearable electronic devices based on a user-defined distance parameter and/or user-defined direction parameter associated with said first wearable electronic device.

22. The system as claimed in claim 16, wherein said one or more circuits are further operable to select said second wearable electronic device and/or one or more other wearable electronic devices based on analysis of sensor data received from said second wearable electronic device and/or said one or more other wearable electronic devices.

23. The system as claimed in claim 16, wherein said one or more circuits are further operable to select said second wearable electronic device and/or one or more other wearable electronic devices based on a position of said second wearable electronic device and/or said one or more other wearable electronic devices located within a threshold range of a user-defined distance parameter and/or a user-defined direction parameter.

24. The system as claimed in claim 16, wherein said one or more circuits are further operable to zoom in, zoom out, and/or pan said shared said at least portion of said FOV of said second wearable electronic device.
